(19) United States
(12) Patent Application Publication
(10) Pub. No.: US 2025/0390099 A1
(43) Pub. Date: Dec. 25, 2025

(54) PATH PLANNING METHOD AND NAVIGATION METHOD AND MOBILE MACHINE USING THE SAME

(71) Applicant: Futronics {NA} Corporation, Pasadena, CA (US)

(72) Inventors: HUAGUANG DU, Pasadena, CA (US); Peijie Xu, Pasadena, CA (US); Zhipeng Liu, Pasadena, CA (US); Wenda Xu, Pasadena, CA (US); Fangyun Zhao, Pasadena, CA (US); Chengkun Zhang, Pasadena, CA (US)

(21) Appl. No.: 18/752,872

(22) Filed: Jun. 25, 2024

(51) Int. Cl. G05D 1/246; G05D 1/633; G05D 1/646; G05D 105/30; G05D 107/60; G05D 111/67

(52) U.S. Cl. CPC G05D 1/2464; G05D 1/633; G05D 1/646; G05D 2105/31; G05D 2107/65; G05D 2111/67

(57) ABSTRACT

Path planning and navigation for a mobile machine is disclosed. A path planning method plans a path for the mobile machine having a plurality of sensors by: receiving, from each of the sensors of the mobile machine, sensor data; creating, based on the received sensor data from each of the sensors, a plurality of local sensor layers each corresponding to the received sensor data from each of the sensors; creating a local map by integrating all the created local sensor layers; inflating the local map; creating a global costmap by fusing an inflated global map and the inflated local map; planning, according to the costmap, the path for navigating the mobile machine; and providing the planned path to the mobile machine for navigating the mobile machine using the planned path.

### TECHNICAL FIELD

The present disclosure relates to navigation technology, and particularly to a path planning method, and a navigation method and a mobile machine using the same.

### BACKGROUND

In navigation technology, the costmap is a cost map in the navigation stack of a mobile robot. Costmap technology is a fundamental component in the path planning for realizing navigation, which leverages sensor input data to construct a detailed 2D or 3D occupancy grid, that is, the costmap of the environment where the mobile robot is to be navigated. Within this grid, each cell is assigned a cost value, effectively encoding information regarding obstacles present in the map. This approach enables mobile robots to plan paths and be navigated efficiently by considering the spatial distribution and cost implications of obstacles within their surroundings.

While current costmap-related techniques serve as indispensable tools in the navigation of mobile robots, they remain constrained by real-world limitations. For instance, certain sensors exhibit restricted field of view (FOV), which results in lacking comprehensive environmental awareness during the navigation of mobile robots. Consequently, the resultant costmaps often lack the comprehensive information necessary for effective path planning, leading to the suboptimal performance of navigation. In addition, existing costmap methods adhere to fixed and smaller map sizes, failing to adapt to the dynamic nature of the high-speed movement of mobile robots since the fast changed environmental parameters are often lost. This limitation compromises information density, particularly in scenarios demanding swift decision-making and obstacle avoidance. Furthermore, conventional costmap algorithms requires large unnecessary computational power and resource utilization, which consequently leads to slow reaction, unprecise path planning and expensive computing hardware. This is largely due to the structure of conventional costmap is not efficient. Still furthermore, the lack of specificity in triggering costmap computation perpetuates inefficiencies, resulting in unnecessary resource utilization and computational waste.

### BRIEF DESCRIPTION OF DRAWINGS

In order to more clearly illustrate the technical solutions in this embodiment, the drawings used in the embodiments or the description of the prior art will be briefly introduced below. In the drawing(s), like reference numerals designate corresponding parts throughout the figures. It should be understood that, the drawings in the following description are only examples of the present disclosure. For those skilled in the art, other drawings can be obtained based on these drawings without creative works.

FIG. 1 is a schematic diagram of a scenario of navigating a mobile machine in a facility according to some embodiments of the present disclosure.

FIG. 2 is a schematic block diagram illustrating a mobile machine according to some embodiments of the present disclosure.

FIG. 3 is a schematic block diagram of an example of navigating the mobile machine of FIG. 2.

FIG. 4 is a flow chart of an example of data reception and preprocessing in the example of FIG. 3.

FIG. 5 is a schematic block diagram of an example of management functionalities specific to building costmaps in the example of FIG. 3.

FIG. 6 is a schematic diagram of a simplized example of inflation according to some embodiments of the present disclosure.

FIG. 7 is a schematic diagram of an example of a costmap according to some embodiments of the present disclosure.

FIG. 8 is a schematic block diagram of an example of costmap providing in the example of FIG. 3.

FIG. 9 is a flow chart of an example of local map creation in the example of FIG. 8.

FIG. 10 is a flow chart of an example of path planning in the example of FIG. 9.

### DETAILED DESCRIPTION

In order to make the objects, features and advantages of the present disclosure more obvious and easy to understand, the technical solutions in this embodiment will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including”, “comprising”, “having” and their variations indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

In the present disclosure, the terms “first”, “second”, and “third” are for descriptive purposes only, and are not to be comprehended as indicating or implying the relative importance or implicitly indicating the amount of technical features indicated. Thus, the feature limited by “first”, “second”, and “third” may include at least one of the feature either explicitly or implicitly. In the description of the present disclosure, the meaning of “a plurality” is at least two, for example, two, three, and the like, unless specifically defined otherwise.

In the present disclosure, the descriptions of “one embodiment”, “some embodiments” or the like described in the specification mean that one or more embodiments of the present disclosure can include particular features, structures, or characteristics which are related to the descriptions of the descripted embodiments. Therefore, the sentences “in one embodiment”, “in some embodiments”, “in other embodiments”, “in other embodiments” and the like that appear in different places of the specification do not mean that descripted embodiments should be referred by all other embodiments, but instead be referred by “one or more but not all other embodiments” unless otherwise specifically emphasized.

The present disclosure relates to navigate a mobile machine. As used herein, the term “mobile machine” refers to a machine such as a mobile robot or a vehicle that has the capability to move around in its environment. The term “path planning” refers to find a sequence of valid configurations that moves a mobile machine from the starting point to the destination, where “path” denotes a sequence of poses without time stamp (cf. “trajectory” denotes a sequence of poses or position with time stamp). The term “pose” refers to position (e.g., x and y coordinates on x and y axes) and posture (e.g., a yaw angle along z axis). The term “navigation” refers to the process of monitoring and controlling the movement of a mobile machine from one place to another. The term “collision avoidance” refers to prevent or reduce the severity of a collision. The term “sensor” refers to a device, module, machine, or subsystem such as ambient light sensor and image sensor (e.g., camera) whose purpose is to detect events or changes in its environment and send the information to other electronics (e.g., processor).

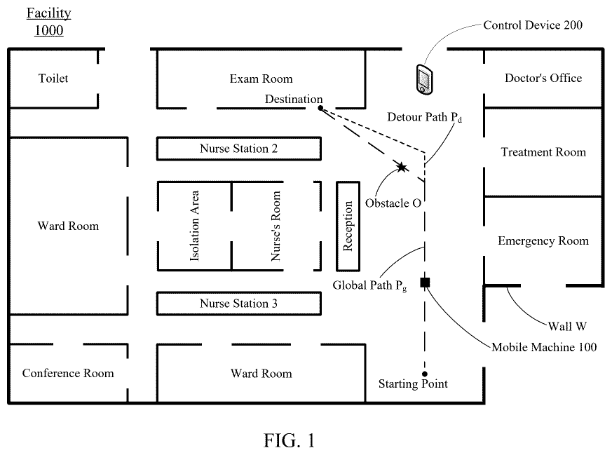

FIG. 1 is a schematic diagram of a scenario of navigating a mobile machine 100 in a facility 1000 according to some embodiments of the present disclosure. In some embodiments, the facility 1000 may be an indoor facility, for example, a health care institution such as a hospital, a health clinic, or a nursing home. In other embodiments, the facility 1000 may be other indoor/outdoor facility such as office, home, factory, shopping mall, airport, railway/bus station, or park. The mobile machine 100 (e.g., a nursing robot) is navigated in the facility 1000 so as to, for example, perform a nursing task such as physical assessment, wound care, mobility assistance, and emergency response, while dangerous situations such as collisions and unsafe conditions (e.g., falling, extreme temperature, radiation, and exposure) are avoided. In this indoor navigation, the mobile machine 100 is navigated from a start point (e.g., the position where the mobile machine 100 originally locates) to a destination (e.g., the position of the goal of navigation which is indicated by a user or a navigation/operation system of the mobile machine 100), while an obstacle O (e.g., human, medical equipment, furniture, or garbage) is avoided so as to prevent the above-mentioned dangerous situations. A path (e.g., global path P_{g}) for the mobile machine 100 to move from the start point to the destination has to be planned so as to move the mobile machine 100 according to the planned path, thereby realizing the navigation of the mobile machine 100.

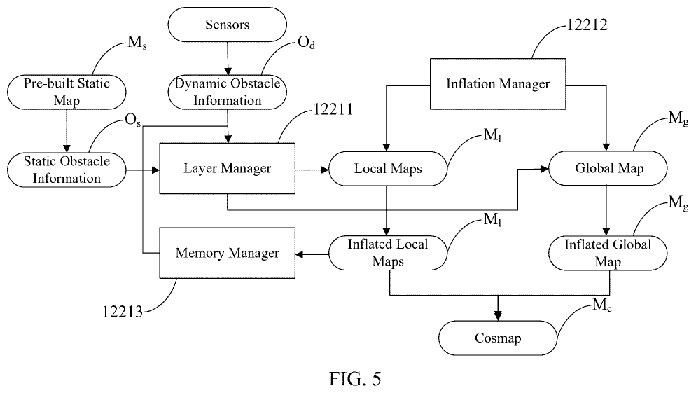

For realizing the path planning (and the navigation) of the mobile machine 100, a static map for the facility 1000 has to be built in advance, and the current (real-time) position of the mobile machine 100 in the facility 1000 has to be determined. For example, a global path (e.g., the global path P_{g}) between the start point and the destination that is in the built static map for the facility 1000 may be planned based on the built static map, and a (real-time) local path (e.g., detour path P_{d}) may be planned based on a local map (e.g., local map Mₗ of FIG. 5), and the determined current position of the mobile machine 100. In some embodiments, the path planning (and navigation) of the mobile machine 100 may be actuated through the mobile machine 100 itself (e.g., a control interface on the mobile machine 100) or a control device 200 such as a remote control, a smart phone, a tablet computer, a notebook computer, a desktop computer, or other electronic device by, for example, providing a request for the navigation and/or the path planning of the mobile machine 100. The mobile machine 100 and the control device 200 may communicate over a network which may include, for example, the Internet, intranet, extranet, local area network (LAN), wide area network (WAN), wired network, wireless networks (e.g., Wi-Fi network, Bluetooth network, and mobile network), or other suitable networks, or any combination of two or more such networks.

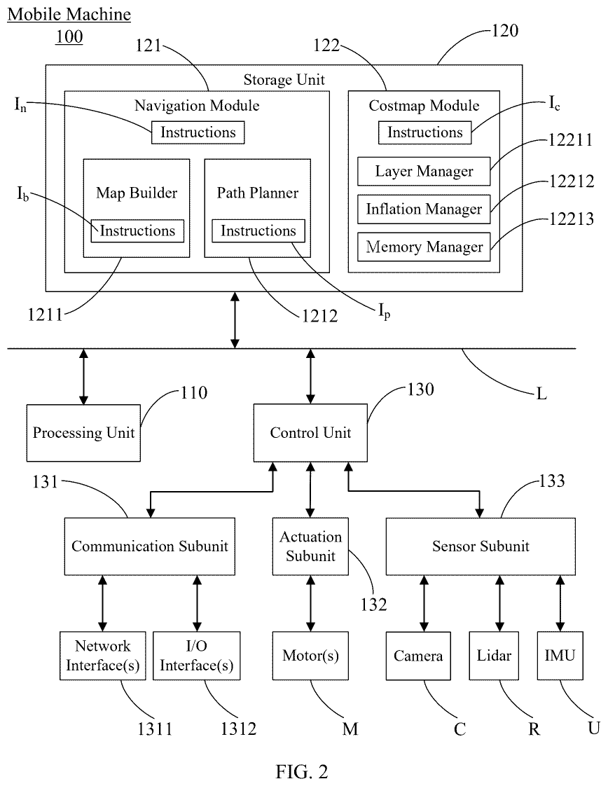

FIG. 2 is a schematic block diagram illustrating the mobile machine 100 according to some embodiments of the present disclosure. The mobile machine 100 may be a mobile robot such as a wheeled robot, which may include a processing unit 110, a storage unit 120, and a control unit 130 that communicate over one or more communication buses or signal lines L. It should be noted that, the mobile machine 100 is only one example of mobile machine, and the mobile machine 100 may have more or fewer components (e.g., unit, subunits, and modules) than shown in above or below, may combine two or more components, or may have a different configuration or arrangement of the components. The processing unit 110 executes various (sets of) instructions stored in the storage unit 120 that may be in form of software programs to perform various functions for the mobile machine 100 and to process related data, which may include one or more processors (e.g., CPU). The storage unit 120 may include one or more memories (e.g., high-speed random access memory (RAM) and non-transitory memory), one or more memory controllers, and one or more non-transitory computer readable storage mediums (e.g., solid-state drive (SSD) or hard disk drive). The control unit 130 may include various controllers (e.g., camera controller, display controller, and physical button controller) and peripherals interface for coupling the input and output peripheral of the mobile machine 100, for example, external port (e.g., USB), wireless communication circuit (e.g., RF communication circuit), audio circuit (e.g., speaker circuit), sensor (e.g., inertial measurement unit (IMU)), and the like, to the processing unit 110 and the storage unit 120. In some embodiments, the storage unit 120 may include a navigation module 121 for implementing navigation functions (e.g., map building and path planning) related to the navigation (and path planning) of the mobile machine 100 and a costmap module 122 for implementing costmap-related functions, which may be stored in the one or more memories (and the one or more non-transitory computer readable storage mediums). In other embodiments, the mobile machine 100 may be a vehicle such as a car, a drone, or a vessel.

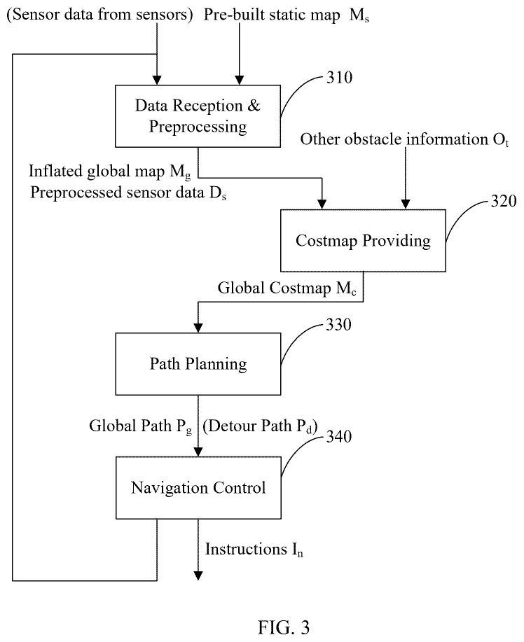

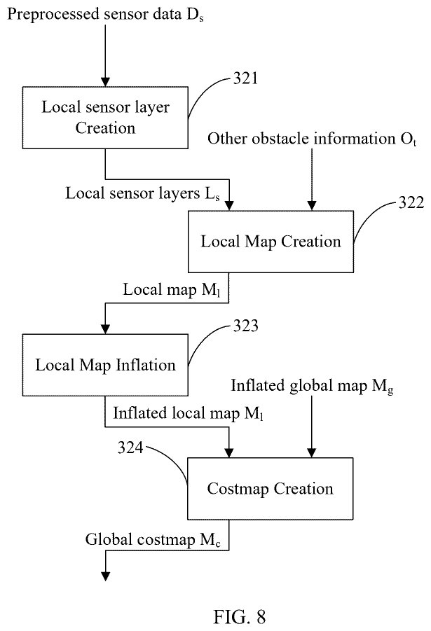

The navigation module 121 in the storage unit 120 of the mobile machine 100 may be a software module (of the operation system of the mobile machine 100) that may belong to a navigation stack (e.g., an ROS (robot operating system) navigation stack) of the mobile machine 100, which has instructions Iₙ (e.g., instruction for actuating motor(s) M of the mobile machine 100 to move the mobile machine 100) for implementing the navigation of the mobile machine 100, a map builder 1211, and path planner(s) 1212. Each of the map builder 1211 and the path planner(s) 1212 may be a submodule separated from the instructions Iₙ or other submodules of the navigation module 121, or a part of the instructions Iₙ for implementing the navigation of the mobile machine 100. The map builder 1211 may be a software module having instructions I_{b} for building maps for the mobile machine 100. The costmap module 122 in the storage unit 120 of the mobile machine 100 may be a software module (of the operation system of the mobile machine 100) that may belong to the navigation stack, which has instructions I_{c} for creating costmaps for the mobile machine 100, and a layer manager 12211, an inflation manager 12212, and a memory manager 12213 that are management functionalities specific to building costmaps (see also FIG. 5). Each of the layer manager 12211, the inflation manager 12212 and the memory manager 12213 may be a submodule separated from the instructions I_{c} or other submodules of the costmap module 122, or a part of the instructions I_{c} for implementing costmap creation. The layer manager 12211 manages local/global map layer (e.g., point cloud layers and grid layers) for each sensor of the mobile machine 100 and pre-built static map, and merges the managed layer to generate initial representations of local/global map. The inflation manager 12212 performs inflation processing on local/global map to generate inflated local/global map, where the inflation processing is based on the size of the mobile machine 100 to ensure sufficient safe operating space of the mobile machine 100. The memory manager 12213 maintains the memory for obstacle information from local maps based on timestamps and manages this information uniformly, and provides real-time sensor data (e.g., sensor data Dₛ in FIG. 3 that is received at the current time frame) and historical sensor data (e.g., the sensor data Dₛ received at previous time frames before the current time frame) to the layer manager 12211 for constructing local sensor layers (local sensor layers Lₛ in FIG. 8). The memory manager 12213 is introduced for building costmaps so as to retain obstacle information beyond the FOV of the mobile machine 100, thereby improving the environmental awareness of the mobile machine 100, and furnishing additional environmental information crucial for the navigation of the mobile machine 100.

The path planner(s) 1212 may be software module(s) having instructions Ip for planning path for the mobile machine 100. In some embodiments, the path planner(s) 1212 may include a global path planner for planning global paths (e.g., the global path P_{g}) for the mobile machine 100 and a local path planner for planning local paths (e.g., the detour path P_{d}) for the mobile machine 100. The global path planner may be, for example, a path planner which plans global paths based on costmap built by the map builder 1211 and/or other map built by the map builder 1211 through, for example, simultaneous localization and mapping (SLAM). The local path planner may be, for example, a path planner based on A*, RRT* (rapidly-exploring random trees), or TEB (timed elastic band) algorithm, which plans local paths based on the global paths, and other data collected by the mobile machine 100. For example, images may be collected through a camera C and/or a Lidar R of the mobile machine 100, and the collected images may be analyzed so as to identify obstacles, so that the local path can be planned with reference to the identified obstacles, and the obstacles can be avoided by moving the mobile machine 100 according to the planned local path. In other embodiments, rather than including the global path planner and the local path planner, the path planner(s) 1212 may include a path planner for planning both the global paths and the local paths. The path planner(s) 1212 may further have data (e.g., input/output data and temporary data) related to the path planning of the mobile machine 100 which may be stored in the one or more memories and accessed by the processing unit 110.

In some embodiments, each of the path planner(s) 1212 may be a module in the storage unit 120 that is separated from the navigation module 121. The instructions Iₙ may include instructions for implementing collision avoidance of the mobile machine 100 (e.g., obstacle detection and detour path planning). In addition, the local path planner may plan a detour path (e.g., the detour path P_{d}) to graft to the global path(s) (e.g., the global path P_{g}) in response to, for example, the original global path(s) being blocked (e.g., blocked by an unexpected obstacle such as the obstacle O) or inadequate for collision avoidance (e.g., impossible to avoid a detected obstacle when adopted). The detour path may be grafted to the global path(s) by replacing a part of the original global path(s) that is near to the obstacle. In other embodiments, the navigation module 121 may be a navigation unit communicating with the processing unit 110, the storage unit 120, and the control unit 130 over the one or more communication buses or signal lines L, and may further include one or more memories (e.g., high-speed random access memory (RAM) and non-transitory memory) for storing the instructions Iₙ, the map builder 1211, and the path planner(s) 1212, and one or more processors (e.g., MPU and MCU) for executing the stored instructions Iₙ, I_{b}, Iₚ, and I_{c} to implement the navigation of the mobile machine 100.

The mobile machine 100 may further include a communication subunit 131 and an actuation subunit 132. The communication subunit 131 and the actuation subunit 132 communicate with the control unit 130 over one or more communication buses or signal lines that may be the same or at least partially different from the above-mentioned one or more communication buses or signal lines L. The communication subunit 131 is coupled to communication interfaces of the mobile machine 100, for example, network interface(s) 1311 for the mobile machine 100 to communicate with the control device 200 via network(s) and I/O interface(s) 1312 (e.g., a physical button), and the like. The actuation subunit 132 is coupled to component(s)/device(s) for implementing the motions of the mobile machine 100 by, for example, actuating motor(s) M of wheels and/or joints of the mobile machine 100. The communication subunit 131 may include controllers for the above-mentioned communication interfaces of the mobile machine 100, and the actuation subunit 132 may include controller(s) for the above-mentioned component(s)/device(s) for implementing the motions of the mobile machine 100. In other embodiments, the communication subunit 131 and/or actuation subunit 132 may just abstract component for representing the logical relationships between the components of the mobile machine 100.

The mobile machine 100 may further include a sensor subunit 133 which may include a set of sensor(s) and related controller(s), for example, the camera C (e.g., an RGB-D camera) and an IMU (inertial measurement unit) U (or an accelerometer and a gyroscope), for detecting the environment in which it is located to realize its navigation. The sensor subunit 133 communicates with the control unit 130 over one or more communication buses or signal lines that may be the same or at least partially different from the above-mentioned one or more communication buses or signal lines L. In other embodiments, in the case that the navigation module 121 is the above-mentioned navigation unit, the sensor subunit 133 may communicate with the navigation unit over one or more communication buses or signal lines that may be the same or at least partially different from the above-mentioned one or more communication buses or signal lines L. In addition, the sensor subunit 133 may be just abstract component for representing the logical relationships between the components of the mobile machine 100. Furthermore, the sensor subunit 133 may further include other sensor for detecting the environment in which the mobile machine 100 is located, for example, an ultrasonic sensor and an infrared (IR) sensor.

In some embodiments, the map builder 1211, the path planner(s) 1212, the sensor subunit 133, and the motor(s) M (and wheels and/or joints of the mobile machine 100 coupled to the motor(s) M) jointly compose a (navigation) system which implements map building, (global and local) path planning, and motor actuating so as to realize the navigation of the mobile machine 100. In addition, the various components shown in FIG. 2 may be implemented in hardware, software or a combination of both hardware and software. Two or more of the processing unit 110, the storage unit 120, the control unit 130, the navigation module 121, and other units/subunits/modules may be implemented on a single chip or a circuit. In other embodiments, at least a part of them may be implemented on separate chips or circuits.

FIG. 3 is a schematic block diagram of an example of navigating the mobile machine 100 of FIG. 2. The mobile machine 100 has a plurality of sensors for navigation (in the view of navigation, individual of the sensors for navigation may have a restricted FOV), for example, the camera C and the Lidar R. In some embodiments, a navigation method for the mobile machine 100 is implemented in the mobile machine 100 for navigating the mobile machine 100 by, for example, storing (sets of) the instructions I_{b} corresponding to map building as the map builder 1211, the instructions Iₚ corresponding to path planning as the path planner(s) 1212, the instructions Iₙ corresponding to navigation (e.g., instructions for controlling the motor(s) M) as the navigation module 121 in the storage unit 120, and the instructions I_{c} corresponding to costmap creation as the costmap module 122 in the storage unit 120, and executing the stored instructions I_{b}, Iₚ, Iₙ and I_{c} through the processing unit 110, then the mobile machine 100 can be navigated according to the path planned based on a built map. Since parameters such as inflation radius, cost values relative to obstacles, and update rates of costmap play a crucial role in optimizing the performance of the costmap module 122, the parameters may be tuned according to the specific environment and the dynamics of the mobile machine 100 so as to ensure effective costmap usage. According to the navigation method, the processing unit 110 may perform data reception and preprocessing on the sensor data Dₛ received from sensors and a pre-built static map Mₛ to provide inflated global map M_{g} and preprocessed sensor data Dₛ (block 310 of FIG. 3).

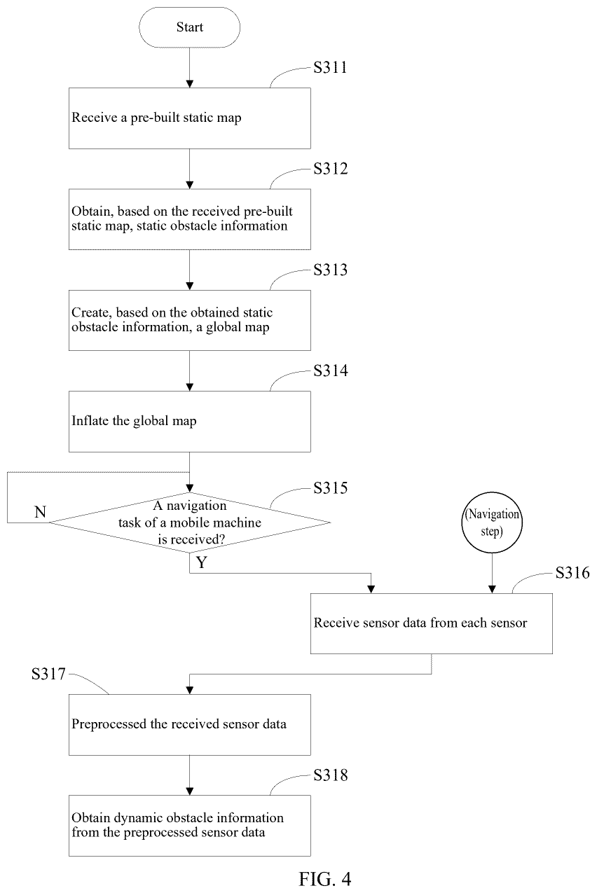

FIG. 4 is a flow chart of an example of the data reception and preprocessing (block 310) in the example of FIG. 3. Step S311-S314 are perform upon the initiation of the navigation stack of the mobile machine 100. Accordingly, at step S311, the pre-built static map Mₛ is received. The pre-built static map Mₛ serves as a foundational reference for the localization and the path planning of the mobile machine 100. The pre-built static map Mₛ may be, for example, a static map of the above-mentioned health care institution that is built using SLAM by the map builder 1211 and stored in (a database in) the storage unit 120. The pre-built static map Mₛ may be received by loading (from the database in the storage unit 120) into the navigation/operation system of the mobile machine 100. At step S312, static obstacle information Oₛ is obtained from the received pre-built static map Mₛ. The static obstacle information Oₛ is information (e.g., the position) of obstacles in the pre-built static map Mₛ, where the obstacles may include static obstacles (e.g., wall W of FIG. 1). FIG. 5 is a schematic block diagram of an example of the management functionalities specific to building costmaps in the example of FIG. 3. The management functionalities include the layer manager 12211, the inflation manager 12212, and the memory manager 12213, which may be layers in the navigation stack of the mobile machine 100. This modular structure of management functionalities specific to building costmaps improves flexibility and scalability by modularizing sensor data fusion, obstacle mapping, map inflation for safe operating space, and the like. Through the layered design, various heterogeneous sensors are efficiently integrated to provide accurate, real-time navigation information for the mobile machine 100. At step S313, the layer manager 12211 creates the global map M_{g} based on the obtained static obstacle information Oₛ. The global map M_{g} is a map for building global paths, which may include static obstacles and dynamic obstacles. At step S314, the inflation manager 12212 inflates the global map M_{g}. The global map M_{g} may be inflated by scaling, using a cost scaling function, a cost value of each cell of the global map M_{g} that is within a predefined inflation radius that corresponds to the radius of the mobile machine 100. Beyond the inflation radius, the cost value becomes 0, indicating that if the mobile machine 100 enters the corresponding cell, it will not collide with any obstacles. The cost value is proportional to the distance between the mobile machine 100 and obstacles, and the cost scaling function scales according to the size of the mobile machine 100 so as to ensure sufficient safe operating space of the mobile machine 100.

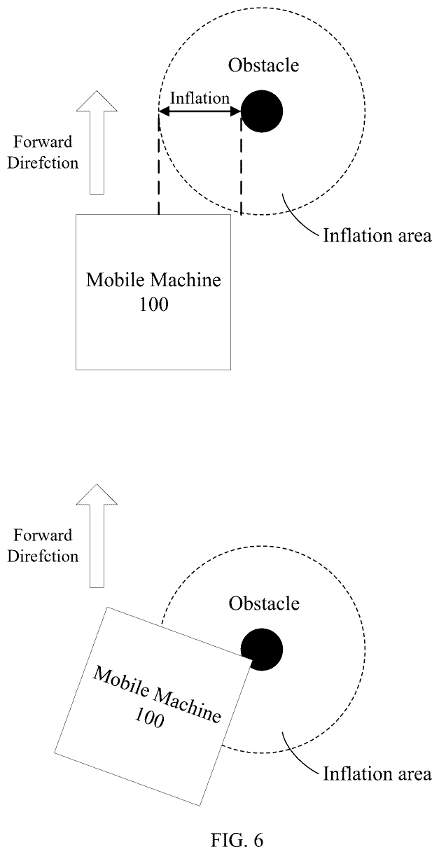

FIG. 6 is a schematic diagram of a simplized example of inflation according to some embodiments of the present disclosure. When a map (e.g., the global map M_{g}) is viewed with the center of the mobile machine 100 that is simplized as a rectangle, in order to avoid the collision with an obstacle (e.g., the obstacle O in FIG. 1), there should be a certain range around the obstacle that the center of the mobile machine 100 cannot enter. The shortest distance which the mobile machine 100 can approach the obstacle is determined by the size of the mobile machine 10, and the range determined by the size of the mobile machine 100 is called “inflation”. The larger the mobile machine 10, the farther away from the obstacle it must be to avoid collision, and the larger the range (i.e., an inflation). In other words, the size of the mobile machine 100 directly determines the magnitude of the inflation, so the size of the mobile machine 100 is directly used to illustrate the value of the inflation. The global map M_{g} is inflated by assigning he cost value of each cell of the global map M_{g} is according to the inflation. As shown in the upper part of FIG. 6, once the distance between the mobile machine 100 and the obstacle is larger than the size of the mobile machine 10, the mobile machine 100 will not collide with the obstacle. The pose (i.e., the position and posture) of the mobile machine 100 also affects. As shown in the lower part of FIG. 6, although moving in the same forward direction, the mobile machine 100 will still collide with the obstacle if the posture of the mobile machine 100 is changed. It should be noted that, the value of the inflations around the obstacle will generally not as simple as shown in FIG. 6 that correspond to a single value (i.e., the inflation radius) and cover a circular area denoted as an inflation area around the obstacle, but may rather correspond to a plurality of values each corresponding to different degrees of collision avoidances.

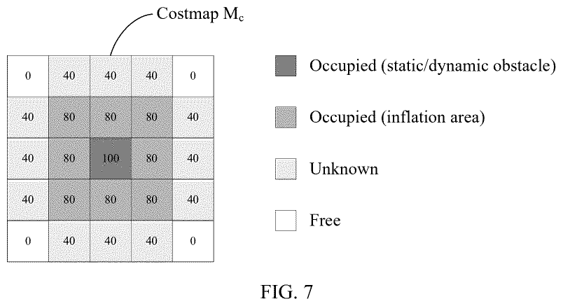

A map represented as an occupancy grid containing a plurality of cells each assigned a (inflated/uninflated) cost value is called a costmap Mc, where the cost value close to obstacles will be higher and the cost value far away from obstacles will be lower. FIG. 7 is a schematic diagram an example of the costmap M_{c} according to some embodiments of the present disclosure. The cell with the cost value of 100 represents an occupied area by static/dynamic obstacle that collision will occur whenever the center of the mobile machine 100 enters; the cell with the cost value of 80 represents an occupied area by the above-mentioned inflation area that collision will occur if the mobile machine 100 enters at certain poses; the cell with the cost value of 40 represents an unknown (undetected) area that collision is possible to occur if the center of the mobile machine 100 enters; and the cell with the cost value of 0 represents a free (unoccupied) area that collision will not occur when the center of the mobile machine 100 enters. By planning a path based on the cost values in the costmap M_{c}, the path with the lowest costs without hitting obstacles can be obtained, which improves the efficiency of path planning and therefore enhances obstacle avoidance.

A trigger logic (see step S315) may be realized for enabling the mobile machine 100 to conserve computational resources when not engaged in navigation tasks. At step S315, it determines whether a navigation task of the mobile machine 100 is received or not. If yes, step S316 will be performed to start a costmap creation process for creating the costmap M_{c}; otherwise, step S315 will be reperformed to loop and wait for a navigation task. The navigation task may be created by the navigation/operation system of the mobile machine 100 for performing the costmap creation process, in response to a request for the navigation of the mobile machine 100. Steps S311-S314 is performed before step S315 so as to speeded-up the initiation of the navigation stack, and may also be performed after step S315 to, for example, perform in parallel with steps S316-S318. Upon receiving the navigation task, the navigation stack of the mobile machine 100 triggers the costmap creation process for creating the costmap M_{c}. At step S316, the sensor data Dₛ is received from each of the sensors for navigation of the mobile machine 100. The sensor data Dₛ is received in a current time frame, that is, the time frame of the current time. When the sensors for navigation include the camera C and the Lidar R, the received sensor data Dₛ include the sensor data Dₛ of the camera C (e.g., images) and that of the Lidar R (e.g., point clouds). At step S317, the received sensor data Dₛ is preprocessed. The received sensor data Dₛ may be preprocessed by, for example, removing sensor noise and/or handling data dropouts. At step S318, dynamic obstacle information O_{d} is obtained from the preprocessed sensor data Dₛ. The dynamic obstacle information O_{d} is information (e.g., the position) of obstacles detected by the sensors for navigation, where the obstacles may include dynamic obstacles that are recognized from the received sensor data Dₛ (e.g., the obstacle O of FIG. 1).

According to the navigation method, the processing unit 110 may further provide the (global) costmap M_{c} for the mobile machine 100 based on the global map M_{g}, the preprocessed sensor data Dₛ, and other obstacle information Oₜ (block 320 of FIG. 3). FIG. 8 is a schematic block diagram of an example of costmap providing (block 320 of FIG. 3) in the example of FIG. 3. According to the costmap providing, the processing unit 110 may create a plurality of local sensor layers Lₛ based on the preprocessed sensor data Dₛ (block 321 of FIG. 8). Each of the local sensor layers Lₛ is configured with predefined size parameters to ensure consistency. The layer manager 12211 may create the local sensor layers Lₛ based on the preprocessed sensor data Dₛ from each of the sensors for navigation, so that each of the created local sensor layers Lₛ corresponds to the preprocessed sensor data Dₛ from each of the sensors for navigation. The processing unit 110 may further create a local map Mₗ based on the created local sensor layers Lₛ and the other obstacle information Oₜ (block 322 of FIG. 8). The other obstacle information Oₜ may include the historical dynamic obstacle information O_{d}, where the historical dynamic obstacle information O_{d} is the dynamic obstacle information O_{d} obtained from the historical sensor data Dₛ received from each of the sensors for navigation of the mobile machine 100 at the previous time frames before the current time frame.

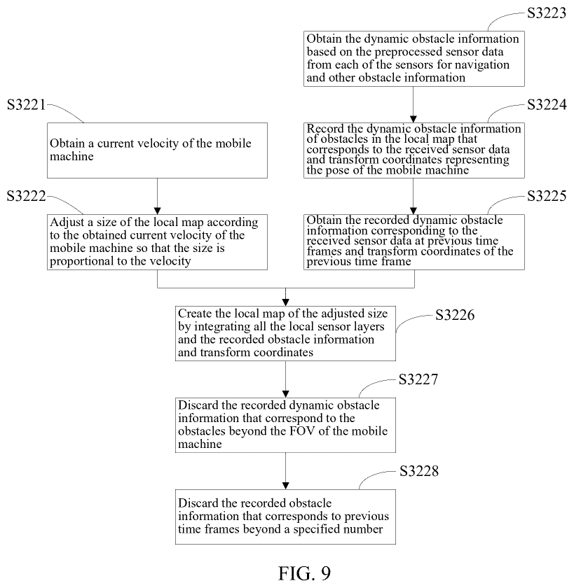

FIG. 9 is a flow chart of an example of local map creation (block 322) in the example of FIG. 8. Accordingly, at step S3221, a current velocity of the mobile machine 100 is obtained. The current velocity of the mobile machine 100 may be obtained using the IMU U. At step S3222, a size of the local map Mₗ is adjusted according to the obtained current velocity of the mobile machine 100 so that the size is proportional to the velocity. The size of the local map Mₗ may be defined in advance according to actual needs and then adjusted according to the obtained current velocity of the mobile machine 100 so that the faster the obtained current velocity of the mobile machine 100, the larger the size of the local map Mₗ. Traditional costmaps are fixed in size and often constrain local maps to dimensions like 5 m×5 m, which is suitable for detecting obstacles in low-speed movement of the mobile machine 100 and is inadequate in detecting obstacles in high-speed movement of the mobile machine 100 with only a 2.5 m buffer ahead. Therefore, by dynamically increasing the size of the local map Mₗ with the increment of the velocity of the mobile machine 100, the obstacle detection capability in high-speed movement of the mobile machine 100 can be improved.

Steps S3221-S3222 are performed in parallel with steps S3223-S3225 so as to speeded-up the initiation of the creation of the local map Mₗ in step S3226. At step S3223, the dynamic obstacle information O_{d} is obtained based on the preprocessed sensor data Dₛ from each of the sensors for navigation and the other obstacle information Oₜ including the historical dynamic obstacle information O_{d}. At step S3224, the memory manager 12213 records the dynamic obstacle information O_{d} of obstacles in the local map Mₗ that corresponds to the sensor data Dₛ received at the current time frame and transform coordinates representing the pose of the mobile machine 100 at the current time frame. The memory manager 12213 significantly reduces the computational burden of the mobile machine 100 by retaining only the transform coordinates of different time frames. At step S3225, the recorded dynamic obstacle information Oa corresponding to the received sensor data Dₛ at the previous time frames and the transform coordinates of the previous time frames are obtained. At step S3226, the layer manager 12211 creates the local map Mₗ of the adjusted size by integrating all the local sensor layers Lₛ and the recorded obstacle information O_{d} (i.e., the historical dynamic obstacle information O_{d}) and transform coordinates. By integrating all the local sensor layers Lₛ and the historical dynamic obstacle information O_{d}, a comprehensive representation of the local map Mₗ can be constructed. The integration may be performed by aligning the historical dynamic obstacle information O_{d} with the current time frame using the transform coordinates; combining the sensor data Dₛ in each of the local sensor layers Lₛ into an empty occupancy grid that is taken as the local map Mₗ; integrating the aligned historical dynamic obstacle information Oa into the grid. The memory manager 12213 may save storage and computational resources and facilitate the rational updates of the costmap M_{c} by selectively discarding the outdated historical dynamic obstacle information O_{d} through a forget logic (see steps S3227-S3228) which spans both spatial and temporal dimension. This dual-dimensional approach optimizes the memory utilization of the mobile machine 100 while upholding the integrity of the navigation/operation system of the mobile machine 100. At step S3227, the memory manager 12213 discards (e.g., removes from a memory of the storage unit 120) the recorded dynamic obstacle information O_{d} of the obstacles that is beyond the FOV of the mobile machine 100. The sensor data Dₛ for obtaining the recorded dynamic obstacle information O_{d} that is within the FOV of the mobile machine 100 is considered ground truth and is retained, while the sensor data Dₛ outside the FOV is systematically erased to ensure real-time accuracy. At step S3228, the memory manager 12213 discards the recorded obstacle information O_{d} of the obstacles that is beyond a specified number (e.g., 100) of the previous time frames. In other embodiments, step S3227 and step S3228 may be performed in a reverse order, or it may perform only one of the steps rather than both.

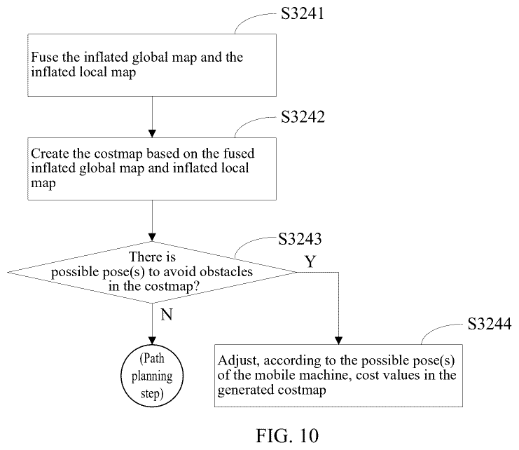

According to the costmap providing, the processing unit 110 may further inflate the local map Mₗ (block 323 of FIG. 8). The local map Mₗ may be inflated by the inflation manager 12212. Similar to the inflation of the global map M_{g}, the local map Mₗ may be inflated by scaling, using the above-mentioned cost scaling function, a cost value of each cell of the local map Mₗ that is within an inflation radius. The processing unit 110 may further create the (global) costmap M_{c} for the mobile machine 100 based on the inflated global map M_{g} and the inflated local map Mₗ (block 324 of FIG. 8). By creating the costmap M_{c} for path planning based on the sensor data Dₛ of different sensors for navigation, the problem of certain sensors restricting the FOV of the mobile machine 100 that affects the resultant costmap M_{c} can be addressed. FIG. 10 is a flow chart of an example of path planning in the example of FIG. 9. At step S3241, the inflated global map M_{g} and the inflated local map Mₗ are fused. The inflated global map M_{g} and the inflated local map Mₗ may be fused by aligning and superimposing the inflated global map M_{g} and the inflated local map Mₗ to a common coordinate system, and performing a cell-by-cell fusion on the inflated global map M_{g} and the inflated local map Mₗ (e.g., for overlapping areas of both map, the higher cost value from either map is chosen, and for non-overlapping areas, the cost value from both maps are directly adopted). At step S3242, the costmap M_{c} is created based on the fused inflated global map M_{g} and inflated local map Mₗ. The costmap M_{c} may be created by initialize an empty occupancy gird that is taken as the local map Mₗ and updating each cell in the gird with the result of the cell-by-cell fusion. The size of the created costmap M_{c} will generally be larger than that of traditional costmap since it is created on the basis of the local map Mₗ created based on the sensor data Dₛ of a plurality of sensors for navigation, which is beneficial in keeping fast changed environmental parameters and is suitable for detecting obstacles in the high-speed movement of mobile machine 100. Correspondingly, due to the large-size costmap will require large memory and computational power, the above-mentioned forget logic is realized to save storage and computational resources and facilitate the rational updates of the costmap M_{c}. At step S3243, it determines whether there is possible pose(s) of the mobile machine 100 to avoid obstacles in the costmap M_{c}. If yes, step S3244 will be performed; otherwise, it will directly perform path planning steps related to the path planning (block 330 of FIG. 3). The possible poses of the mobile machine 100 for avoiding the obstacles in the costmap M_{c} may be obtained according to the size and the shape of the mobile machine 100. At step S3244, the cost values in the created costmap M_{c} are adjusted (updated) according to the obtained possible pose(s) of the mobile machine 100. By moving the mobile machine 100 according to the path planned using the adjusted costmap M_{c}, collisions can be avoided in a more effective manner during the movement of the mobile machine 100.

According to the navigation method, the processing unit 110 may further perform path planning based on the created costmap M_{c} to provide the global path P_{g} (and the detour path P_{d}) (block 330 of FIG. 3). The detour path P_{d} will be provided upon detecting obstacles. The processing unit 110 may further perform navigation control on the mobile machine 100 by providing the instructions Iₙ based on the planned global path P_{g} (and the detour path P_{d}) (block 340 of FIG. 3). After performing navigation steps related to the navigation control, it may back to step S316 for receiving the new sensor data Dₛ from the sensors for navigation at the next time frame after the current time frame.

By focusing on enhancing FOV adaptability, dynamic map sizing, and intelligent computational resource management, a novel framework of costmap architecture is provided, which improves navigational precision and efficiency in real-world environment.

It can be understood by those skilled in the art that, all or part of the method in the above-mentioned embodiment(s) can be implemented by one or more computer programs to instruct related hardware. In addition, the one or more programs can be stored in a non-transitory computer readable storage medium. When the one or more programs are executed, all or part of the corresponding method in the above-mentioned embodiment(s) is performed. Any reference to a storage, a memory, a database or other medium may include non-transitory and/or transitory memory. Non-transitory memory may include read only memory (ROM), programmable ROM (PROM), electrically programmable ROM (EPROM), electrically erasable programmable ROM (EEPROM), flash memory, solid-state drive (SSD), or the like. Volatile memory may include random access memory (RAM), external cache memory, or the like.

The processing unit 110 (and the above-mentioned processor) may include central processing unit (CPU), or be other general purpose processor, graphics processing unit (GPU), digital signal processor (DSP), application specific integrated circuit (ASIC), field-programmable gate array (FPGA), or be other programmable logic device, discrete gate, transistor logic device, and discrete hardware component. The general purpose processor may be microprocessor, or the processor may also be any conventional processor. The storage unit 120 (and the above-mentioned memory) may include internal storage unit such as hard disk and internal memory. The storage unit 120 may also include external storage device such as plug-in hard disk, smart media card (SMC), secure digital (SD) card, and flash card.

The exemplificative units/modules and methods/steps described in the embodiments may be implemented through software, hardware, or a combination of software and hardware. Whether these functions are implemented through software or hardware depends on the specific application and design constraints of the technical schemes. The above-mentioned path planning method and mobile machine may be implemented in other manners. For example, the division of units/modules is merely a logical functional division, and other division manner may be used in actual implementations, that is, multiple units/modules may be combined or be integrated into another system, or some of the features may be ignored or not performed. In addition, the above-mentioned mutual coupling/connection may be direct coupling/connection or communication connection, and may also be indirect coupling/connection or communication connection through some interfaces/devices, and may also be electrical, mechanical or in other forms.

The above-mentioned embodiments are merely intended for describing but not for limiting the technical schemes of the present disclosure. Although the present disclosure is described in detail with reference to the above-mentioned embodiments, the technical schemes in each of the above-mentioned embodiments may still be modified, or some of the technical features may be equivalently replaced, so that these modifications or replacements do not make the essence of the corresponding technical schemes depart from the spirit and scope of the technical schemes of each of the embodiments of the present disclosure, and should be included within the scope of the present disclosure.

What is claimed is:

1. A method for navigating a mobile machine having a plurality of sensors, comprising:
obtaining a global map;
inflating the global map; and
in response to receiving a navigation task of the mobile machine:
creating a global costmap for the mobile machine by performing a costmap creation process;
planning, based on the costmap, a path for navigating the mobile machine; and
navigating the mobile machine using the planned path;
wherein, the costmap creation process includes:
receiving, from each of the sensors of the mobile machine, sensor data;
creating, based on the received sensor data from each of the sensors, a plurality of local sensor layers each corresponding to the received sensor data from each of the sensors;
creating a local map by integrating all the local sensor layers;
inflating the local map; and
creating the costmap for the mobile machine by fusing the inflated global map and the inflated local map.

2. The method of claim 1, further comprising:
obtaining, based on the received sensor data from each of the sensors, dynamic obstacle information; and
recording the obtained dynamic obstacle information of obstacles in the local map that corresponds to the received sensor data at a current time frame and transform coordinates representing a pose of the mobile machine at the current time frame.

3. The method of claim 2, further comprising:
discarding the recorded dynamic obstacle information of the obstacles that is beyond at least one of a field of view of the mobile machine and a specified number of previous time frames before the current time frame.

4. The method of claim 2, wherein creating the local map by integrating all the local sensor layers comprises:
creating the local map by integrating all the local sensor layers, the recorded dynamic obstacle information corresponding to the received sensor data at previous time frames before the current time frame and the transform coordinates of the previous time frames.

5. The method of claim 1, further comprising:
adjusting a size of the local map according to a velocity of the mobile machine so that the size is proportional to the velocity.

6. The method of claim 1, wherein the global map is a pre-built static map corresponding to a facility, and obtaining the global map comprises:
obtaining, based on the static map, static obstacle information; and
creating, based on the obtained static obstacle information, the global map.

7. The method of claim 1, wherein the costmap is a map having a plurality of cells each with a cost value with respect to obstacles; wherein planning, based on the created costmap, the path for navigating the mobile machine comprises:
planning, according to the costs in the created costmap, the path for navigating the mobile machine while avoiding the obstacles.

8. A method for planning a path for navigating a mobile machine having a plurality of sensors, comprising:
receiving, from each of the sensors of the mobile machine, sensor data;
creating, based on the received sensor data from each of the sensors, a plurality of local sensor layers each corresponding to the received sensor data from each of the sensors;
creating a local map by integrating all the created local sensor layers;
inflating the local map;
creating a global costmap for the mobile machine by fusing an inflated global map and the inflated local map;
planning, according to the costmap, the path for navigating the mobile machine; and
providing the planned path to the mobile machine for navigating the mobile machine using the planned path.

9. The method of claim 8, wherein the method is performed in response to receiving a navigation task of the mobile machine.

10. The method of claim 8, further comprising:
obtaining, based on the received sensor data from each of the sensors, dynamic obstacle information; and
recording the obtained dynamic obstacle information of obstacles in the local map that corresponds to the received sensor data at a current time frame and transform coordinates representing a pose of the mobile machine at the current time frame.

11. The method of claim 10, further comprising:
discarding the recorded dynamic obstacle information of the obstacles that is beyond at least one of a field of view of the mobile machine and a specified number of previous time frames before the current time frame.

12. The method of claim 10, wherein creating the local map by integrating all the local sensor layers comprises:
creating the local map by integrating all the local sensor layers, the recorded dynamic obstacle information corresponding to the received sensor data at previous time frames before the current time frame and the transform coordinates of the previous time frames.

13. The method of claim 8, further comprising:
adjusting a size of the local map according to a velocity of the mobile machine so that the size is proportional to the velocity.

14. A mobile machine, comprising:
one or more sensors;
one or more processors; and
one or more memories storing a costmap module configured to be executed by the one or more processors, wherein the costmap module comprises a layer manager and an inflation manager, and the costmap module comprises instructions to:
receive, from each of the sensors of the mobile machine, sensor data;
create, using the layer manager based on the received sensor data from each of the sensors, a plurality of local sensor layers each corresponding to the received sensor data from each of the sensors;
create, using the layer manager, a local map by integrating all the created local sensor layers;
inflate, using the inflation manager, the local map;
create a global costmap for the mobile machine by fusing an inflated global map and the inflated local map;
plan, according to the costmap, a path for navigating the mobile machine; and
provide the planned path to the mobile machine for navigating the mobile machine using the planned path.

15. The mobile machine of claim 14, wherein the costmap module is triggered to execute by the one or more processor in response to receiving a navigation task of the mobile machine.

16. The mobile machine of claim 14, wherein the costmap module further comprises instructions to:
obtain the global map;
inflate the global map; and
navigate the mobile machine using the planned path.

17. The mobile machine of claim 14, wherein the costmap module further comprises a memory manager, and further comprises instructions to:
obtain, based on the received sensor data from each of the sensors, dynamic obstacle information; and
record, using the memory manager, the obtained dynamic obstacle information of obstacles in the local map that corresponds to the received sensor data at a current time frame and transform coordinates representing a pose of the mobile machine at the current time frame.

18. The mobile machine of claim 17, wherein the costmap module further comprises instructions to:
discard, using the memory manager, the recorded dynamic obstacle information of the obstacles that is beyond at least one of a field of view of the mobile machine and a specified number of previous time frames before the current time frame.

19. The mobile machine of claim 17, wherein creating the local map by integrating all the local sensor layers comprises:
creating, using the layer manager, the local map by integrating all the local sensor layers, the recorded dynamic obstacle information corresponding to the received sensor data at previous time frames before the current time frame and the transform coordinates of the previous time frames.

20. The mobile machine of claim 14, wherein the costmap module further comprises instructions to:
adjust a size of the local map according to a velocity of the mobile machine so that the size is proportional to the velocity.
